(19) United States
(12) Patent Application Publication
(10) Pub. No.: US 2026/0100654 A1
(43) Pub. Date: Apr. 9, 2026

(54) POWER CONVERSION DEVICE AND A MAGNETIC ASSEMBLY

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/351,257

(22) Filed: Oct. 6, 2025

(30) Foreign Application Priority Data
Oct. 8, 2024 (CN) 202411390173.9
Oct. 21, 2024 (CN) 202411470251.6

(51) Int. Cl. H02M 3/335; H02M 3/00

(52) U.S. Cl. CPC H02M 3/33576; H02M 3/003; H02M 3/01

(57) ABSTRACT

A power conversion device is provided. By optimizing the winding manner of the high-voltage winding and the low-voltage winding and the layout of corresponding components, the output capability of the power conversion device is improved, and the loss on the energy transmission path is reduced; On the other hand, by means of the assembly structure of the first substrate and the second substrate, a winding is provided on the second substrate, and the magnetic core is assembled to the second substrate from the upper surface and the lower surface of the second substrate, respectively; a hole groove is provided on the first substrate, and the hole groove is used for accommodating an upper magnetic plate of the magnetic core assembly; thus, the volume of the power conversion device is further reduced, and the height difference of the main heating element is reduced, thereby achieving a low thermal resistance.

### CROSS-REFERENCE TO RELATED APPLICATIONS

This application claims the priority benefit of China application serial no. 202411390173.9, filed on Oct. 8, 2024, and China application serial no. 202411470251.6, filed on Oct. 21, 2024. The entirety of the above-mentioned patent application is hereby incorporated by reference herein and made a part of this specification.

### DESCRIPTION OF RELATED ART

With the development of artificial intelligence, the power requirements of intelligent data processing chips, such as GPU/CPU/NPU, etc. (collectively, xPU) are increasingly high, so that the power of the server is increased, the input voltage of the server gradually changes from 12V to 48V, and the operating voltage of the xPU is increasingly low as the process progresses, and gradually moves from 0.8 V to 0.65 V. Therefore, the ratio of the input voltage to the output voltage becomes larger and larger, so that the two-stage buck circuit architecture gradually becomes the mainstream; the two-stage buck circuit architecture comprises a front-stage proportional converter and a rear-stage voltage regulator.

Provided in the present application is a power conversion circuit, used for converting a 48V input voltage into a pre-stage ratio converter of an intermediate bus voltage, which can meet the requirements of an input voltage to an output voltage ratio of 4:1. By optimizing the winding manner of the transformer winding and the layout of the power device, and by designing the structure of the power conversion device in the vertical direction, the characteristics of low loss, small volume and low thermal resistance of the front-stage proportional converter are realized.

### SUMMARY

In view of the above, one of the objectives of the application is to provide a power conversion device, comprising a substrate, a magnetic core assembly, and at least two lower switches; the magnetic core assembly comprises a magnetic column, an upper magnetic plate and a lower magnetic plate, and the magnetic column is arranged between the upper magnetic plate and the lower magnetic plate; the substrate comprises a hole-groove and a winding, the winding is arranged in the substrate or on the surface of the substrate, the hole groove is used for the magnetic column to pass through, the upper magnetic plate and the lower magnetic plate are respectively assembled to the winding from the upper surface and the lower surface of the substrate, the at least two lower switches are arranged on the upper surface of the substrate, and the at least two lower switches are respectively arranged on two opposite sides of the magnetic core assembly;

The power conversion device further includes an input end and an output end, the input end includes an input positive end and an input negative end, and the output end includes an output positive end and an output negative end.

Preferably, the magnetic core assembly comprises two magnetic columns, and a channel between the magnetic columns is a winding channel; The magnetic core assembly further comprises a first side and a third side opposite to each other, and an second side and a fourth side opposite to each other, wherein the winding channel penetrates through the first side and the third side of the magnetic core assembly; the winding comprises a first winding and a second winding, the first winding and the second winding respectively pass through the winding channel once in opposite directions, and the second end of the first winding is electrically connected to the second end of the second winding.

Preferably, the winding further comprises a third winding, and the third winding passes through the winding channel twice.

Preferably, a first end of the third winding is disposed adjacent to a first side of the magnetic core assembly, and a second end of the third winding is disposed adjacent to a third side of the magnetic core;

The winding manner of the third winding is as follows: the third winding from the first end to the second end, first passes through the winding channel in the first direction, is divided into two branches, is wound around the two magnetic columns along the third side, and then converges at the winding channel on the first side, and passes through the winding channel again in the first direction to reach the third side.

Preferably, the power conversion device, comprising a first sub-circuit, a second sub-circuit, a third sub-circuit, and a fourth sub-circuit; each sub-circuit comprises a lower switch and an upper switch and a middle switch connected in series in sequence; the upper switches of the first sub-circuit and the second sub-circuit are electrically connected in parallel and are connected in parallel between the input positive end and a first upper node, the middle switches of the first sub-circuit and the second sub-circuit are electrically connected in parallel, one parallel terminal of the two parallel switches is electrically connected to the first upper node, and the other parallel terminal is electrically connected to a first lower node or the input negative end; the lower switches of the first sub-circuit and the second sub-circuit are electrically connected in parallel and connected between the first lower node and the output negative end; the upper switches of the third sub-circuit and the fourth sub-circuit are electrically connected in parallel and connected between the input positive end and a second upper node, the middle switches of the third sub-circuit and the fourth sub-circuit are electrically connected in parallel, one parallel terminal of the two parallel switches is electrically connected to a second upper node, the other parallel terminal is electrically connected to a second lower node or the input negative end, and lower switches of the third sub-circuit and the fourth sub-circuit are electrically connected in parallel and connected between the second lower node and the output negative end.

Preferably, the power conversion device, further comprising a resonant capacitor, wherein a first end of the third winding is connected in series with the resonant capacitor and then connected between the first upper node and the second upper node, and a connection point between the first end of the third winding and the resonant capacitor is a series connection point.

Preferably, a first end of the first winding is electrically connected to the first lower node, a first end of the second winding is electrically connected to the second lower node, and a second end of the first winding and a second end of the second winding are electrically connected to the output positive end.

Preferably, the first end of the first winding and the second end of the second winding are arranged adjacent to the first side, and the second end of the first winding and the first end of the second winding are arranged adjacent to the third side; the second end of the first winding and the second end of the second winding are electrically connected by means of an auxiliary connection line, and the auxiliary connection line is arranged around the periphery of the magnetic assembly and forms a closed loop.

Preferably, the lower switches of the first sub-circuit and the second sub-circuit are disposed adjacent to the first side; the lower switches of the third sub-circuit and the fourth sub-circuit are disposed adjacent to the third side.

Preferably, in the first sub-circuit, the upper switch and the middle switch are arranged adjacent to the second side, and the middle switch is arranged adjacent to the lower switch; in the second sub-circuit, the upper switch and the middle switch are disposed adjacent to the fourth side, and the middle switch is disposed adjacent to the lower switch; in the third sub-circuit, the upper switch and the middle switch are disposed adjacent to the second side, and the middle switch is disposed adjacent to the lower switch; in the fourth sub-circuit, the upper switch and the middle switch are disposed adjacent to the fourth side, and the middle switch is disposed adjacent to the lower switch.

Preferably, the substrate comprises a first substrate and a second substrate, the first substrate and the second substrate both comprise an upper surface and a lower surface opposite to each other, and the lower surface of the first substrate is disposed adjacent to the upper surface of the second substrate; The first substrate comprises a hole-groove for accommodating the upper magnetic plate; the second substrate comprises a hole-groove for the magnetic column to pass through; the hole-groove of the second substrate is arranged in a vertical projection area of the hole-groove of the first substrate on the upper surface of the second substrate; and the lower magnetic plate is arranged adjacent to the lower surface of the second substrate.

Preferably, the first substrate and the second substrate are fixed and electrically connected by welding, pressing, or metal columns.

Preferably, an upper surface of the first substrate comprises a first sub-circuit region, a second sub-circuit region, a third sub-circuit region, a fourth sub-circuit region, a first lower switch region and a second lower switch region; the first sub-circuit area is used for arranging the upper switch and the middle switch of the first sub-circuit, the second sub-circuit area is used for arranging the upper switch and the middle switch of the second sub-circuit, the third sub-circuit area is used for arranging the upper switch and the middle switch of the third sub-circuit, and the fourth sub-circuit area is used for arranging the upper switch and the middle switch of the fourth sub-circuit.

Preferably, the lower surface of the second substrate comprises a first output capacitor region, a second output capacitor region, a first input capacitor region, a second input capacitor region, a first resonant capacitor region and a second resonant capacitor region; the first output capacitor region and the second output capacitor region are respectively arranged on the first side and the third side; the first input capacitor region and the second input capacitor region are respectively arranged on the second side and the fourth side and are used for arranging an input capacitor; the first resonant capacitor region and the second resonant capacitor region are respectively arranged on the second side and the fourth side and are used for arranging a resonant capacitor; the projection of the first output capacitor region on the upper surface of the first substrate at least partially overlaps the first lower switch region, and the projection of the second output capacitor region on the upper surface of the first substrate at least partially overlaps the second lower switch region.

Preferably, the first lower switch region is configured to arrange the lower switch of the first sub-circuit and the second sub-circuit, and the second lower switch region is configured to arrange the lower switch of the third sub-circuit and the fourth sub-circuit; and the first output capacitor region and the second output capacitor region are configured to set an output capacitor.

Preferably, the first lower switch region is configured to set a lower switch and an output capacitor of the first sub-circuit, the second lower switch region is configured to arrange the lower switch and the output capacitor of the third sub-circuit, the first output capacitor region is configured to arrange the lower switch and the output capacitor of the second sub-circuit, and the second output capacitor region is configured to arrange the lower switch and the output capacitor of the fourth sub-circuit.

Preferably, the power conversion device, further comprising a third substrate and a connector, wherein the third substrate comprises an upper surface and a lower surface opposite to each other, and the upper surface of the third substrate is disposed adjacent to the lower surface of the second substrate; the connector is disposed between the upper surface of the third substrate and the lower surface of the second substrate for being fixed and electrically connected to the second substrate and the third substrate; the lower surface of the third substrate is provided with a connecting portion for being fixed and electrically connected to the external assembly; the connector is configured to transmit a signal and/or transmit energy.

Preferably, the power conversion device, further comprising a third substrate, wherein the third substrate comprises an upper surface and a lower surface opposite to each other, and the upper surface of the third substrate is disposed adjacent to the lower surface of the second substrate; the first substrate, the second substrate, and the third substrate are fixed and electrically connected by means of a metal column. The second substrate further comprises a hole groove for the metal column to pass through; the metal column is used for transmitting a signal and/or transferring energy.

Preferably, the first end of the first winding and the second end of the second winding are arranged adjacent to the first side, and the second end of the first winding and the first end of the second winding are arranged adjacent to the third side; the first end of the first winding, the second end of the second winding, and the second end of the third winding are dotted terminals.

Preferably, the power conversion device further comprises a first control signal, a second control signal, a third control signal and a fourth control signal; the first control signal and the second control signal are 180 degrees out of phase, and the duty cycles are 0.5; the third control signal is complementary to the first control signal, and the fourth control signal is complementary to the second control signal; the first control signal is used for controlling the turn-on and turn-off of the upper switches of the first sub-circuit and the second sub-circuit, the middle switches the third sub-circuit and the fourth sub-circuit; the second control signal is used for controlling the turn-on and turn-off of the upper switches of the third sub-circuit and the fourth sub-circuit, the middle switches of the first sub-circuit and the second sub-circuit; the third control signal is used for controlling the turn-on and turn-off of the lower switches of the third sub-circuit and the fourth sub-circuit; and the fourth control signal is used for controlling the turn-on and turn-off of the lower switches of the first sub-circuit and the second sub-circuit.

Preferably, a first end of the third winding extends to the second side and the fourth side along the first side, and is electrically connected to a connection point provided in the first resonant capacitor area and the second resonant capacitor area, respectively; the second end of the third winding extends to the second side and the fourth side along the third side, respectively, and is electrically connected to the second upper node provided in the third sub-circuit area and the fourth sub-circuit area, respectively.

A magnetic assembly, comprising a substrate and a magnetic core assembly, wherein the magnetic core assembly comprises a magnetic column, an upper magnetic plate and a lower magnetic plate, and the magnetic column is arranged between the upper magnetic plate and the lower magnetic plate; the magnetic core assembly comprises a first side and a third side opposite to each other, and a second side and a fourth side opposite to each other;
the substrate comprises a hole-groove and a winding, the winding is arranged in the substrate or on the surface of the substrate, the hole-groove is used for the magnetic column to pass through, and the upper magnetic plate and the lower magnetic plate are respectively assembled to the winding from the upper surface and the lower surface of the substrate; the magnetic column comprises a middle column, two first side columns and one second side column; the middle column is surrounded by the two first side columns and the second side column, and an enclosed angle around the middle column is greater than 180 degrees; two channels between the middle column and the two first side columns, and a channel between the middle column and the second side column are connected in series, and the series channel is used for arranging the winding.

Preferably, the two first side columns are respectively arranged adjacent to the second side and the fourth side of the magnetic core assembly, the second side column is arranged adjacent to the third side of the magnetic core assembly, and the middle column is arranged between the two first side columns and the second side column; the substrate further comprises two first side-grooves and one second side-groove, the two first side-grooves are respectively used for the two first side columns to pass through, the second side-groove is used for the second side column to pass through, and the hole-grooves allow the middle column to pass through; and after the magnetic core assembly is assembled to the substrate, the second side, the third side, and the fourth side of the magnetic core assembly are exposed on the side wall of the substrate.

Preferably, the upper magnetic plate and/or the lower magnetic plate comprise a first recess and a second recess, the first recess is disposed adjacent to the third side of the magnetic core assembly, and the second recess is disposed adjacent to the first side of the magnetic core assembly.

A power conversion device, comprising two switch bridge arms and a magnetic assembly, wherein each of the switch bridge arms comprises two lower switches connected in parallel, the four lower switches are arranged along the first side of the magnetic core assembly, and lower switches of the two switch bridge arms are arranged in a staggered manner; the power conversion device further includes an input end and an output end, the input end includes an input positive end and an input negative end, and the output end includes an output positive end and an output negative end.

Preferably, each of the two switch bridge arms further comprises an upper switch and a middle switch; the upper switch, the middle switch and the parallelled lower switches in the same switch bridge arm are connected in series in sequence; the middle switch is arranged between the upper switch and the lower switch; the input negative end and the output negative end are short-circuited; the switch bridge arm is connected between the input positive end and the input negative end.

Preferably, the drain electrodes of the two lower switches of a first bridge arm of the two switch bridge arms are connected in parallel and then are electrically connected to the winding, and the drains of the two lower switches of a second bridge arm of the two switch bridge arms are electrically connected to the winding after being connected in parallel.

Preferably, the upper switch, the middle switch and the lower switch of each of the two switch bridge arms are arranged on the upper surface of the substrate; and the upper switch, the middle switch and the lower switch are sequentially arranged in the same direction.

Preferably, the power conversion device, further comprising a resonant capacitor, an input capacitor, and an input positive electrical connector; the resonant capacitor is disposed on the upper surface of the substrate and located between the upper switches of the two switch bridge arms; the input capacitor and the input positive electrical connector are disposed on the lower surface of the substrate and are disposed adjacent to the upper switch.

Preferably, the power conversion device, further comprising a connector; wherein the connector is disposed on the first recess and the second recess of the upper magnetic plate or on the first recess of the lower magnetic plate; and the connector is used for heat dissipation and mechanical support.

Preferably, the power conversion device, the input negative end and the output negative end are electrical connected; wherein the power conversion device further comprises a output positive electrical connector and a grounding electrical connector; wherein the output positive electrical connector is disposed in the second recess of the lower magnetic plate, and is electrical connected with the output positive end; the grounding electrical connector is disposed adjacent to the output positive electrical connector, and is electrical connector with the input negative end and the output negative end.

Preferably, the upper magnetic plate and/or the lower magnetic plate comprises two first recesses and one second recess, one of the first recesses is disposed adjacent to the second side and the third side of the magnetic core assembly, and the other first recess is disposed adjacent to the third side and the fourth side of the magnetic core assembly; and the second recess is disposed adjacent to the first side of the magnetic core assembly.

Preferably, the upper magnetic plate and/or the lower magnetic plate comprise a first recess and a second recess, the first recess is arranged at an intermediate position on the third side, and the second recess is arranged adjacent to the first side of the magnetic core assembly.

Preferably, the power conversion device, further comprising another substrate and an input positive electrical connector; wherein the input positive electrical connector is disposed on the lower surface of the substrate; wherein the another substrate comprises an upper surface and a lower surface opposite to each other, and the input positive electrical connector, the output positive electrical connector and the grounding electrical connector are fixed and electrically connected to the another substrate; the lower surface of the another substrate comprises a plurality of connecting portions, the plurality of connecting portions being electrically connected to the electrical connectors by means of the another substrate; and the plurality of connecting portions being used for being fixed and electrically connected to an external assembly.

Compared with the prior art, the application has the following beneficial effects:
(1) The present application provides a power conversion device. By optimizing the winding manner of the high-voltage winding and the low-voltage winding and the layout of corresponding components, the output capability of the power conversion device is improved, and the loss on the energy transmission path is reduced;
(2) On the other hand, in the present application, by means of the assembly structure of the first substrate and the second substrate, a winding is provided on the second substrate, and the magnetic core is fastened to the second substrate from the upper surface and the lower surface of the second substrate, respectively; A hole groove is provided on the first substrate, and the hole groove is used for accommodating the upper magnetic plate of the magnetic core assembly. In this way, the volume of the power conversion device is further reduced; moreover, the height difference of the heating device such as the magnetic core and the switch is reduced, the thermal resistance of the heating source and the top heat sink is reduced, and the heat dissipation performance is improved.

### BRIEF DESCRIPTION OF THE DRAWINGS

FIG. 1A is a power conversion circuit.

FIG. 1B is another power conversion circuit.

FIG. 2 is a control timing sequence.

FIG. 3A to FIG. 3C are partial three-dimensional schematic diagrams of a power conversion device.

FIG. 4A to FIG. 4C are winding schematic diagrams of a winding.

FIG. 5A and FIG. 5B are three-dimensional schematic diagrams of a power conversion device.

FIG. 6 is another three-dimensional schematic diagram.

FIG. 7A and FIG. 7B are another schematic layout diagram.

FIG. 8 is another power conversion circuit.

FIG. 9A to FIG. 9D are schematic structural diagrams of another power conversion device.

FIG. 10A and FIG. 10B are schematic structural diagrams of another power conversion device.

### DESCRIPTION OF THE EMBODIMENTS

One of the cores of the present application is to provide a carrier board having a high integration level and a power module.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

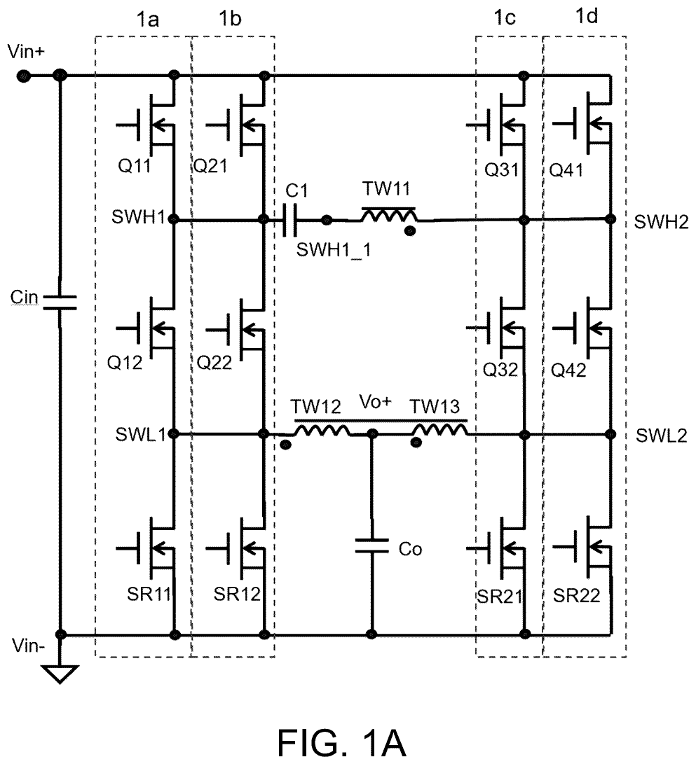

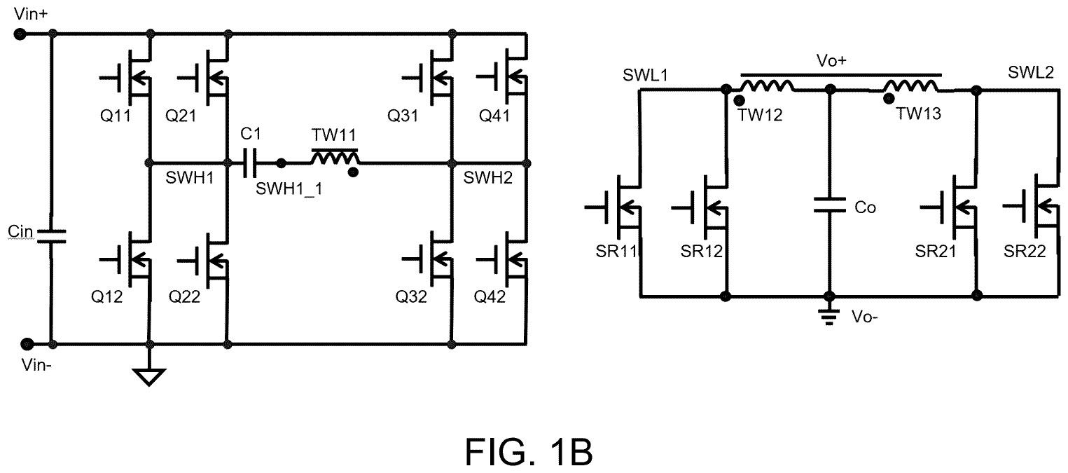

The proportional converter circuit disclosed in the present application is shown in FIG. 1A and FIG. 1B, FIG. 1A is an isolated power conversion circuit topology, and FIG. 1B is an isolated power conversion circuit topology. As shown in FIG. 1A, the non-isolated power conversion circuit comprises an input end, an output end, a first bridge arm, a second bridge arm, a magnetic assembly and a resonant capacitor; the input end comprises an input positive end Vin+ and an input negative end Vin−, and the output terminal comprises an output positive end Vo+ and an output negative end Vo−; and in the present embodiment, the input negative end Vin− and the output negative end Vo− are shorted; the first bridge arm comprises a first sub-circuit 1a and a second sub-circuit 1b, the second bridge arm comprises a third sub-circuit 1c and a fourth sub-circuit 1d, and each sub-circuit comprises an upper switch, a middle switch and a lower switch connected in series in sequence. For example, the first sub-circuit 1a comprises an upper switch Q11, a middle switch Q12 and a lower switch SR11 connected in series in sequence; The second sub-circuit 1b comprises an upper switch Q21, a middle switch Q22, and a lower switch SR12 connected in series in sequence, wherein the upper switches Q11 and Q21 are connected in parallel to the input positive end Vin+ and the first upper node SWH1, the middle switches Q12 and Q22 are connected in parallel to the first upper node SWH1 and the first lower node SWL1, and the lower switches SR11 and SR12 are connected in parallel to the first lower node SWL1 and the input negative end Vin−. The third sub-circuit 1c comprises an upper switch Q31, a middle switch Q32 and a lower switch SR21 connected in series in sequence; The fourth sub-circuit comprises an upper switch Q41, a middle switch Q42 and a lower switch SR22 connected in series in sequence, wherein the upper switches Q31 and Q41 are connected in parallel to the input positive end Vin+ and the second upper node SWH2, the middle switches Q32 and Q42 are connected in parallel to the second upper node SWH2 and a second lower node SWL2, and the lower switches SR21 and SR22 are connected in parallel to the second lower node SWL2 and the input negative end Vin−. The magnetic assembly comprises a high-voltage winding TW11, a first low-voltage winding TW12 and a second low-voltage winding TW13, wherein the high-voltage winding TW11 and the resonant capacitor C1 are electrically connected in series to the connection point SWH1-1, and the high-voltage winding TW11 and the resonant capacitor C1 are connected in series to form a series branch, and the series branch is connected across the first upper node SWH1 and the second upper node SWH2. A second end of the first low voltage winding TW12 and a second end of the second low voltage winding TW13 are electrically connected to the output positive end Vo+, a first end of the first low voltage winding TW12 is electrically connected to the first lower node SWL1, and a first end of the second low voltage winding TW13 is electrically connected to the second lower node SWL2. The proportional converter circuit further includes an input capacitor Cin and an output capacitor Co, the input capacitor Cin is connected between the input positive end Vin+ and the input negative end Vin−, and the output capacitor Co is connected across the output positive end Vo+ and the output negative end Vo−. The second end (equivalent to an upper node SWH2) of the high-voltage winding TW11, the first end (equivalent to a lower node SWL1) of the first low-voltage winding TW12 and the second end (equivalent to an output positive end Vo+) of the second low-voltage winding TW13 are with the same polarity, and are labeled as point ends.

The isolated power conversion circuit shown in FIG. 1B differs from that shown in FIG. 1A in that the input negative end Vin− and the output negative end Vo− are not shorted. The isolated power conversion circuit also includes a first sub-circuit, a second sub-circuit, a third sub-circuit, and a fourth sub-circuit, each sub-circuit comprises an upper switch and a middle switch electrically connected in series, and a lower switch. The switches Q12 and Q22 are connected in parallel between the first upper node SWH1 and the input negative end Vin−, and the middle switches Q32 and Q42 are connected in parallel between the second upper node SWH2 and the input negative end Vin−, and the input capacitor Cin is connected between the input positive end Vin+ and the input negative end Vin−. The connection manner of other components is the same as that of FIG. 1A, and details are not described again.

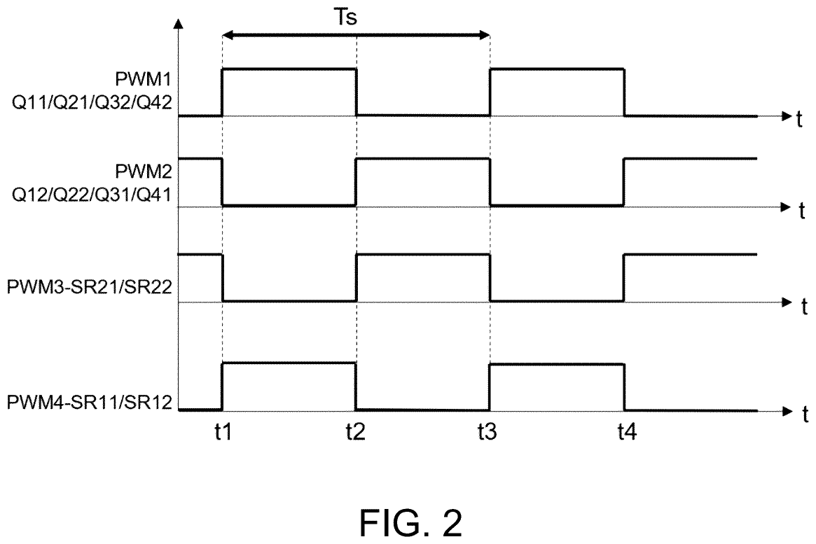

The power conversion device using the circuit shown in FIG. 1A and FIG. 1B may use the control timing as shown in FIG. 2. In detail, the power conversion device further comprises a first control signal PWM1, a second control signal PWM2, a third control signal PWM3, and a fourth control signal PWM4. As shown in FIG. 2, the time t1 to t3 is one switching period Ts. Ignoring the dead time, the duty cycle of the first control signal PWM1 and the second control signal PWM2 is 50%, and the first control signal PWM1 and the second control signal PWM2 are 180 phase shift degrees; the third control signal PWM3 is complementary to the first control signal PWM1, and the fourth control signal PWM3 is complementary to the second control signal PWM2. The first control signal PWM1 is used for controlling the turn-on and turn-off of the upper switch Q11/Q21 and the medium switch Q32/Q42, the second control signal PWM2 is used for controlling the turn-on and turn-off of the switch Q12/Q22 and the upper switch Q31/Q41, the third control signal PWM3 is used for controlling the turn-on and turn-off of the lower switch SR21/SR22, and the fourth control signal PWM4 is used for controlling the turn-on and turn-off of the lower switch SR11/SR12.

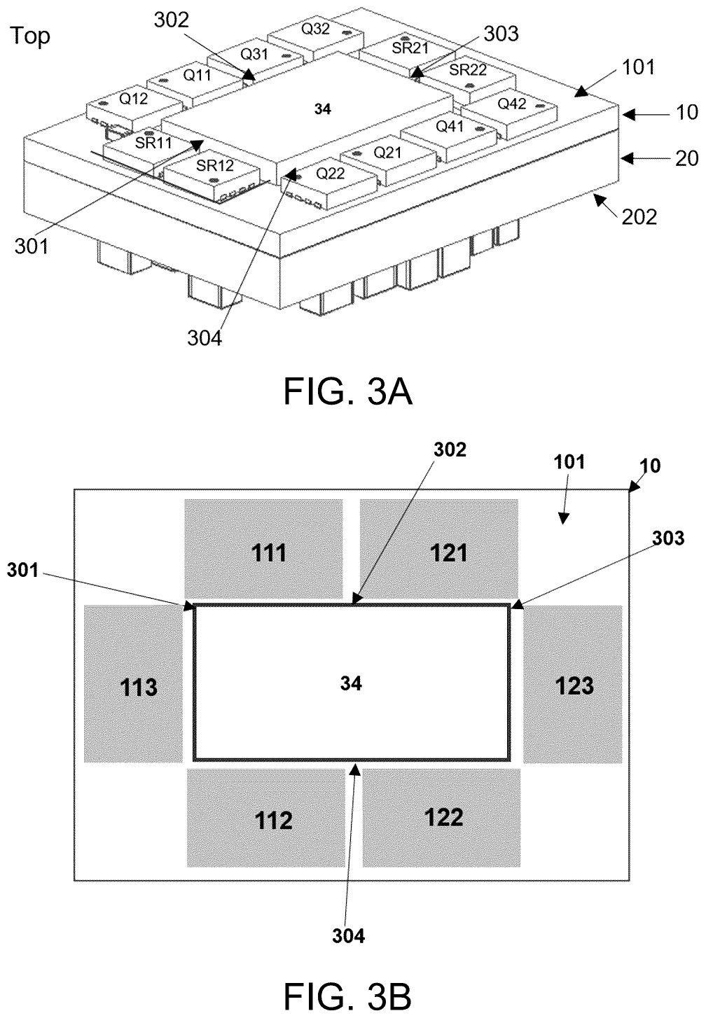

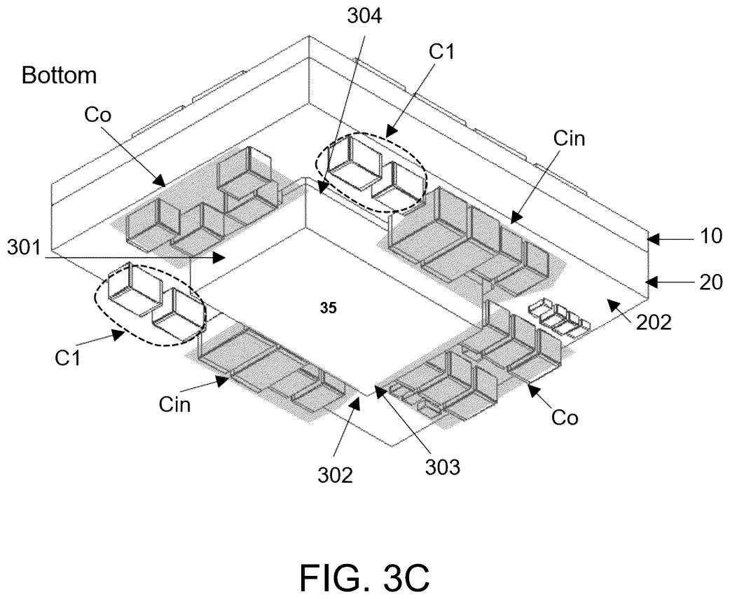

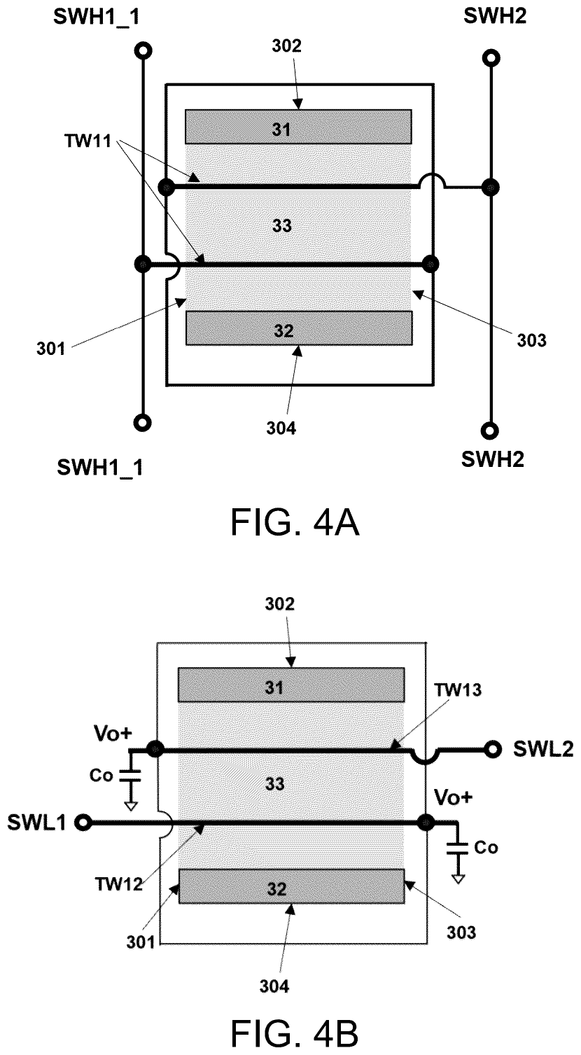

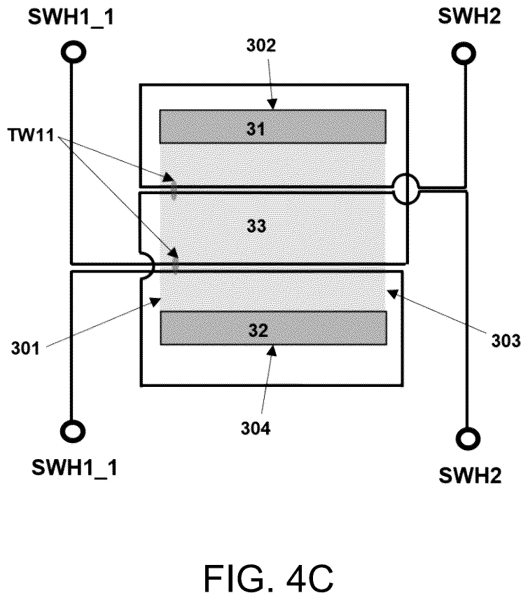

In order to obtain a power conversion device with higher conversion efficiency and lower thermal resistance, the present application further optimizes the winding method of the magnetic component and the structural layout of the device. FIG. 3A is a schematic diagram of a partial structure of a power conversion device. The power conversion device comprises a first substrate 10 and a second substrate 20. The first substrate 10 comprises an upper surface 101 and a lower surface 102 opposite to each other. The second substrate 20 comprises an upper surface 201 and a lower surface 202 which are opposite to each other, wherein the lower surface 102 and the upper surface 201 are attached and electrically connected, and the bonding method can be welding or pressing the first substrate and the second substrate again, but not limited thereto. Referring to FIGS. 3B-3C, and FIGS. 4A-4C, the magnetic core assembly 30 includes an upper magnetic plate 34, a lower magnetic plate 35, magnetic columns 31 and 32, and a channel between the magnetic columns 31 and 32 is a winding channel 33; the magnetic core assembly 30 further comprises a first side 301 and a third side 303 opposite to each other, and an second side 302 and a fourth side 304 opposite to each other; the winding channel 33 penetrates through the first side 301 and the third side 303.

The plurality of semiconductor switches is disposed on the upper surface 101, and can be simultaneously arranged with reference to the top surface layout shown in FIG. 3B. The upper surface 101 comprises a first lower switch region 113 and a second lower switch region 123, the first lower switch region 113 and the second lower switch region 123 are respectively arranged on two opposite sides of the magnetic core assembly, that is, the first lower switch region 113 is arranged on the first side 301, the second lower switch region 123 is arranged on the third side 303, the first lower switch region 113 is used for arranging the lower switch SR11 and the SR12 of the first bridge arm, and the second lower switch region is used for arranging the lower switch SR21 and the SR22. The upper surface 101 further comprises a first sub-circuit region 111, a second sub-circuit region 112, a third sub-circuit region 121 and a fourth sub-circuit region 122; The first sub-circuit region 111 and the third sub-circuit region 121 are arranged on the second side 302, the second sub-circuit region 112 and the fourth sub-circuit region 122 are arranged on the fourth side 304; the first sub-circuit region 111 and the second sub-circuit region 112 are arranged adjacent to the first lower switch region 113, and the third sub-circuit region 121 and the fourth sub-circuit region 122 are arranged adjacent to the second lower switch region 123. The first sub-circuit region 111 is used for arranging the upper switch Q11 and the middle switch Q12 of the first sub-circuit 1a, the second sub-circuit region 112 is used for arranging the upper switch Q21 and the middle switch Q22 of the second sub-circuit 1b, the third sub-circuit region 121 is used for arranging the upper switch Q31 and the middle switch Q32 of the third sub-circuit 1c, and the fourth sub-circuit region 122 is used for setting the upper switch Q41 and the middle switch Q42 of the fourth sub-circuit 1d; Each middle switch is disposed adjacent to the lower switch of the same sub-circuit, such as the middle switch Q12 being disposed adjacent to the lower switch SR11.

A plurality of capacitors are disposed on the lower surface 202, the lower surface 202 comprises a first output capacitor area and a second output capacitor area, the first output capacitor area and the second output capacitor area are respectively arranged on the first side 301 and the third side 303, and the first/second output capacitor area is used for arranging an output capacitor Co; and the projection of the first output capacitor area on the upper surface 101 is at least partially overlapped with the first lower switch area, and the projection of the second output capacitor area on the upper surface 101 at least partially overlaps the second lower switch area. The lower surface 202 further comprises a first input capacitor region and a second input capacitor region, wherein the first input capacitor region and the second input capacitor region are respectively arranged on the second side 302 and the fourth side 304, and the first/second input capacitor region is used for arranging an input capacitor Cin. The lower surface 202 further comprises a first resonant capacitor region and a second resonant capacitor region, the first resonant capacitor region and the second resonant capacitor region are respectively arranged on the second side 302 and the fourth side 304, and the first/second resonant capacitor region is used for arranging the layout of a resonant capacitor C1. the arrangement of the input capacitor region and the resonant capacitor region, is shown in FIG. 3C, but is not limited thereto, and the position of the input capacitor region and the resonant capacitor region on the same side can also be exchanged.

FIG. 4A shows the winding manner of the high voltage winding TW11, FIG. 4B shows the winding manner of the low voltage winding TW12 and TW13, and FIG. 4C shows another winding manner of the high voltage winding TW11. In detail. As shown in FIG. 4A, the first end of the high-voltage winding TW11 is disposed adjacent to the first side 301, and extends along the first side 301 to the second side 302 and the fourth side 304, respectively, and is electrically connected to the node SWH1-1 provided in the first sub-circuit area and the node SWH1-1 provided in the second sub-circuit area. A second end of the high-voltage winding TW11 is arranged adjacent to the third side 303, and extends along the third side 303 to the second side 302 and the fourth side 304, respectively, and is electrically connected to a node SWH2 provided in the third sub-circuit area and a node SWH2 provided in the fourth sub-circuit area. The high voltage winding TW11 is from the first end to the second end, first passes from the first side 301 through the winding channel 33 from left to right (the first direction), then divides into two branches, respectively wraps around the magnetic column 31 and the magnetic column 32 along the third side 303, then converges at the winding channel 33 of the first side 301, passes through the winding channel 33 again in the first direction, and reaches the third side 303.

FIG. 4B shows a winding manner of the low-voltage winding TW12 and the TW13, a first end (SWL1) of the first low-voltage winding TW12 being provided on the first side 301, and a second end (Vo+) thereof being provided on the third side 303; a first end (SWL2) of the second low-voltage winding TW13 is provided on the third side 303, and a second end (Vo+) thereof is provided at the first side 301 of the first low-voltage winding TW12 from the first end to the second end and passes through the winding channel 33 in the first direction; The second low voltage winding TW13 passes from the first end to the second end through the winding channel 33 from right to left (second direction), the output capacitor Co is respectively disposed on the first side 301 and the third side 303, and is connected to the output positive end Vo+ and the ground line nearby. On the other hand, the output positive end Vo+ located on the first side 301 is electrically connected to the output positive end Vo+ located at the third side 303 by means of an auxiliary connection line, and the auxiliary connection line is provided around the periphery of the magnetic core assembly to form a closed loop for the communication signal to circulate and reduce the interconnection impedance between the output capacitors.

The winding manner of the high-voltage winding TW11 may also be as shown in FIG. 4C, different from that shown in FIG. 4B, the windings starting from the nodes SWH1-1 of the first sub-circuit region and the nodes SWH1-1 of the second sub-circuit region do not merge, respectively pass through the winding channel 33, be wound around the magnetic column 31 and the magnetic column 32 respectively along the third side 303, pass through the winding channel 33 again in the first direction, reach the third side 303, and then are electrically connected to the node SWH2 provided in the third sub-circuit area and the node SWH2 provided in the fourth sub-circuit area, respectively. The node SWH1-1 from the first sub-circuit region may also pass through the winding channel and then be connected to the node SWH2 of the fourth sub-circuit region. The node SWH1-1 of the second sub-circuit region may also be connected to the node SWH2 of the third sub-circuit region after passing through the winding channel.

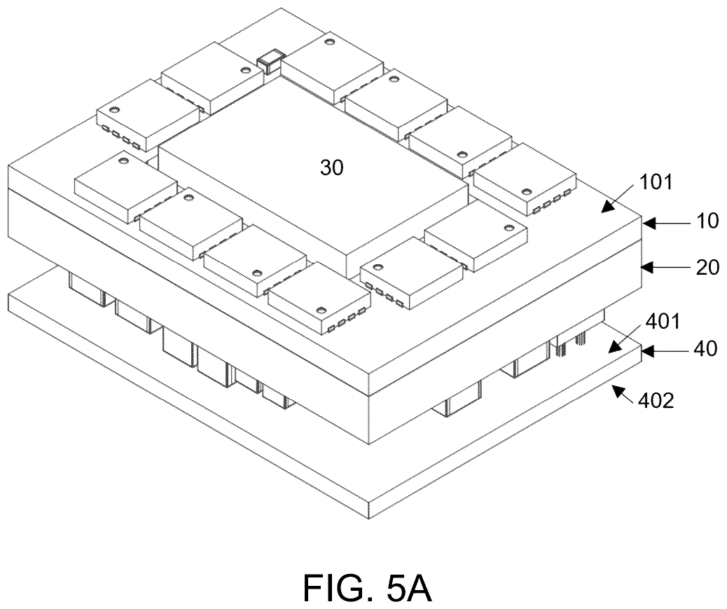

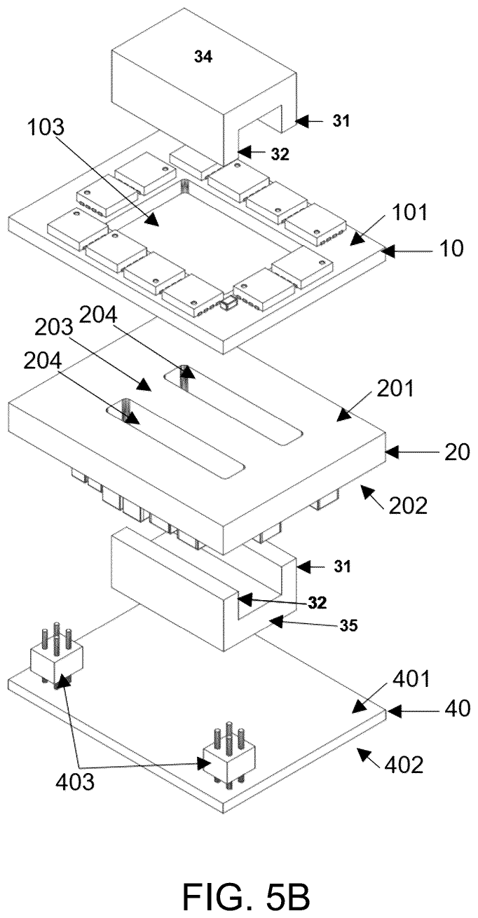

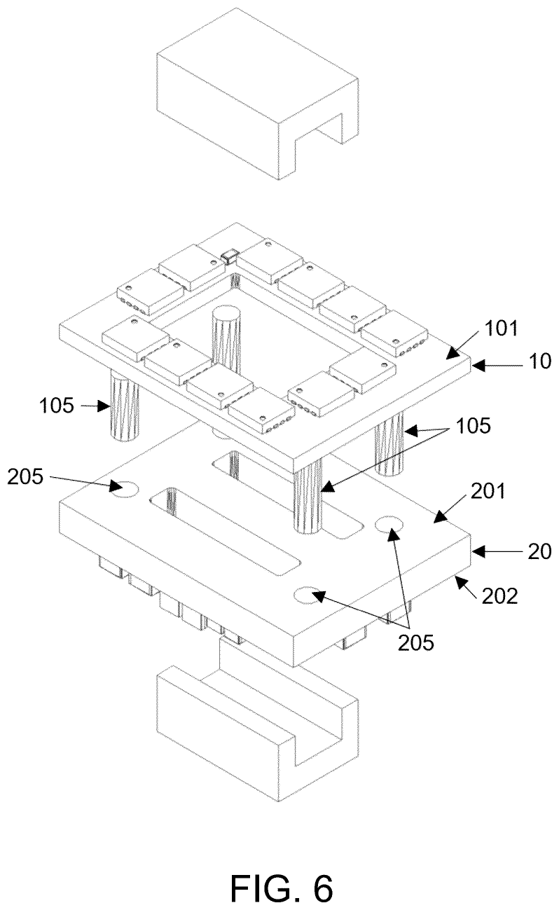

The power conversion device further comprises a third substrate 40, the third substrate 40 comprising an upper surface 401 and a lower surface 402 opposite to each other, the upper surface 401 being disposed adjacent to the lower surface 202, as shown in FIG. 5A. FIG. 5B shows a schematic three-dimensional exploded view of a power conversion device. The first substrate 10 further comprises a hole-groove 103. The hole groove 103 is used for accommodating the upper magnetic plate 34. The second substrate 20 comprises two hole-grooves 204 respectively for the magnetic columns 31 and 32 to pass through. After the first substrate 10 and the second substrate 20 are assembled, the two hole-grooves 204 are exposed in the hole groove 103, that is, the hole-groove of the second substrate is provided in the vertical projection area of the hole-groove of the first substrate on the upper surface of the second substrate. The high-voltage winding TW11 and the low-voltage windings TW12 and TW13 are arranged in or on the surface of the second substrate 20, and the upper magnetic plate 34 and the lower magnetic plate 35 respectively assembled the second substrate from the upper surface 101 and the lower surface 202, and provide a coupling loop for the high-voltage winding and the low-voltage winding. The number of magnetic columns and the number of hole-grooves in the second substrate are not limited thereto, as long as the number of magnetic columns corresponds to the number of hole-grooves on the second substrate.

The power conversion device further comprises two connectors 403 for fixing the second substrate 20 and the third substrate 40, and electrically connecting the second substrate 20 and the third substrate 40 for transmitting power and signals, etc. The shape and number of the connectors 403 are only examples, and can be adjusted according to the actual design. A plurality of pads or BGA arrays (not shown) may be provided on the lower surface 402 for energy and signal transmission of the external components.

FIG. 6 shows another structure. The main difference lies in that a metal pillar 105 is fixed and electrically connected between a first substrate 10 and a second substrate 20, and a plurality of hole-grooves 205 are further comprised on the second substrate 20 for the metal pillars 105 to pass through. The material of the metal pillar 105 may be copper or a metal having good electrical conductivity. An upper end of the metal pillar 105 is fixed and electrically connected to a lower surface 102 of the first substrate 10, and is electrically connected to a corresponding wiring on the second substrate 20. After the first substrate 10 and the second substrate 20 are assembled by means of the copper pillars 105, the copper pillars 105 may protrude from the lower surface 202, and the lower ends of the copper pillars 105 are fixed and electrically connected to the upper surface 401 of the third substrate 40; and the first substrate 10 and the second substrate 20 may also be fixed and electrically connected by means of the connectors 403 as shown in FIG. 5B.

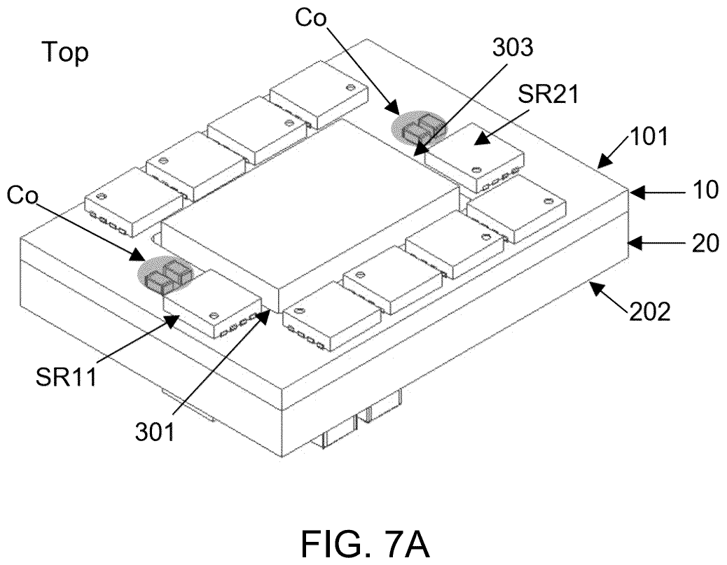

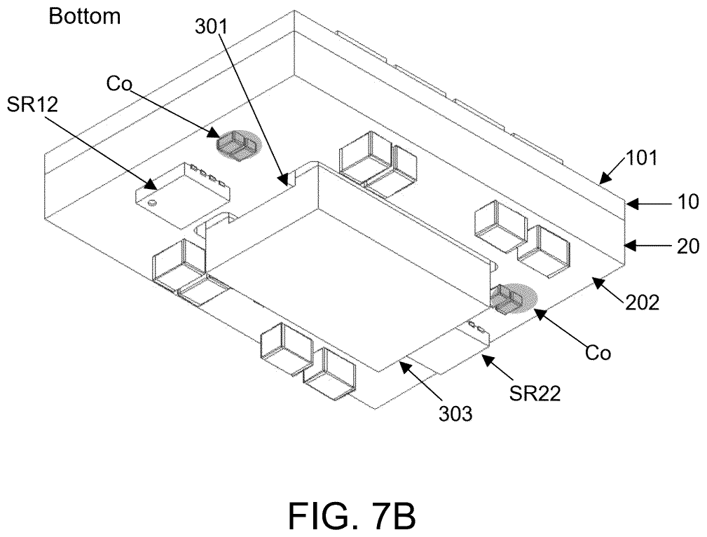

FIGS. 7A and 7B show another arrangement of components, which differs from FIGS. 3A to 3C in that the lower switch SR11 is provided on the first side 301 of the upper surface 101 and the lower switch SR12 is provided on the first side 301 of the lower surface 202; the lower switch SR21 is provided on the third side 303 of the upper surface 101, the lower switch SR22 is provided on the first side 301 of the lower surface 202, and the output capacitor Co is respectively provided on the upper surface 101 and the lower surface 202, and is respectively arranged adjacent to each lower switch. The lower switches SR11 and SR12 achieve the shortest distance connection in the vertical direction, which can further reduce the loss on the transmission path. According to the layout disclosed in the present embodiment, the first substrate 10 and the second substrate 20 can also be fixed and electrically connected by means of a metal column; similarly, the present embodiment can also comprise a third substrate 40, and the third substrate 40 and the second substrate 20 can be fixedly electrically connected by means of the connector 403, and can also be fixed and electrically connected by means of the metal column.

The structure and layout of the disclosed power conversion device are applicable to the circuit topology shown in FIG. 1B, as long as the wiring connection is adjusted according to the difference between FIG. 1A and FIG. 1B. In addition, the structure and layout of the power conversion device disclosed in the present disclosure are also applicable to an adjustable power conversion device.

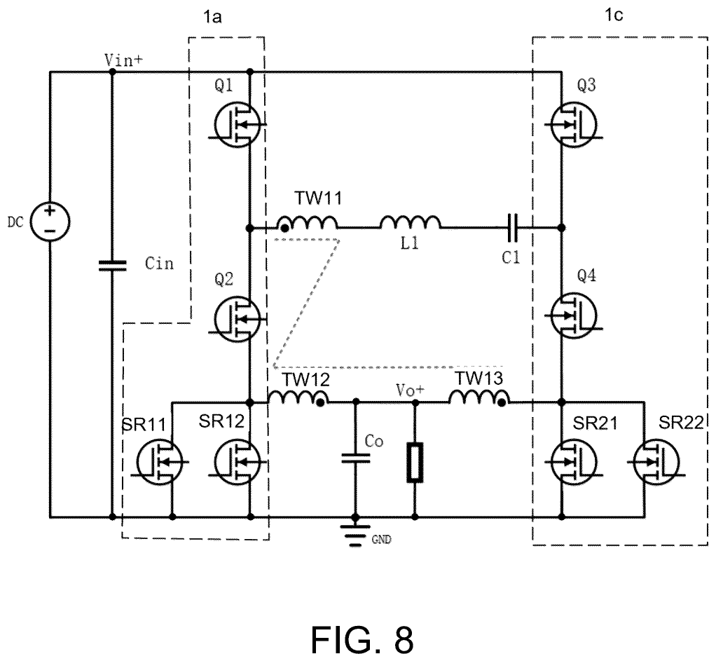

Another embodiment is also disclosed, the circuit diagram is shown in FIG. 8, and differs from the circuit diagram shown in FIG. 1A in that the first switch bridge arm only comprises a first sub-circuit 1a, and the second switch bridge arm only comprises a third sub-circuit 1c. The first sub-circuit 1a comprises an upper switch Q1, an middle switch Q2 and a lower switch SR11/SR12, wherein the lower switch SR11 and the SR12 are electrically connected in parallel; the third sub-circuit 1c comprises an upper switch Q3, an middle switch Q4 and a lower switch SR21/SR22, wherein the lower switch SR21 and the SR22 are electrically connected in parallel. In another embodiment, the middle switch Q2 can be implemented in parallel using two switches, and the middle switch Q4 can be implemented in parallel by using two switches. The magnetic assembly comprises a high-voltage winding TW11, a low-voltage winding TW12, and a TW13. The resonant inductor L1 is an equivalent inductance, can be an equivalent leakage inductance of the magnetic assembly, or can also be an external inductor, or a sum of equivalent leakage inductance and external inductance.

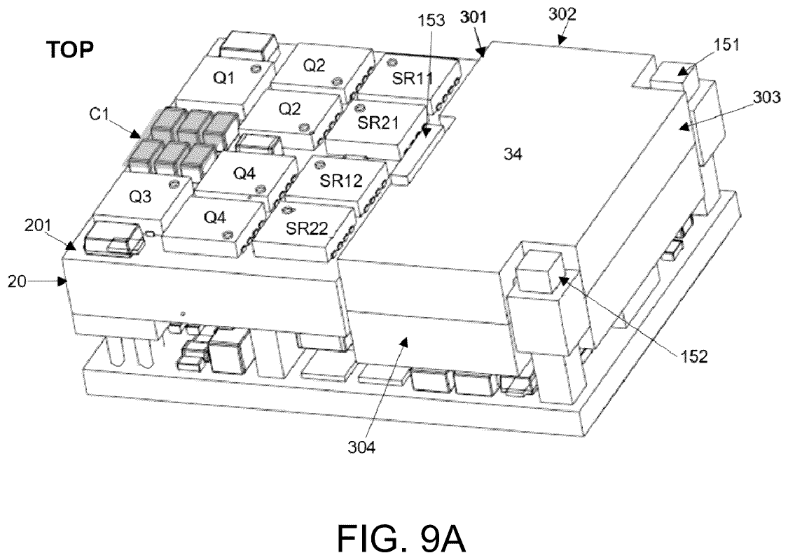

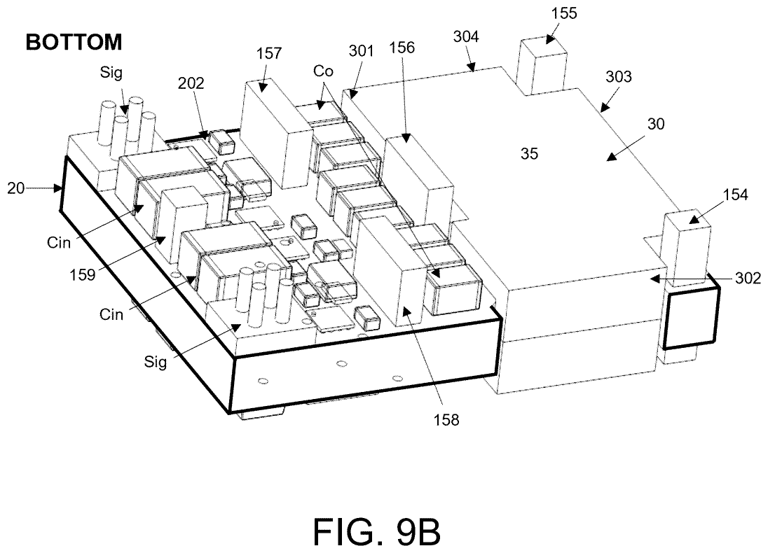

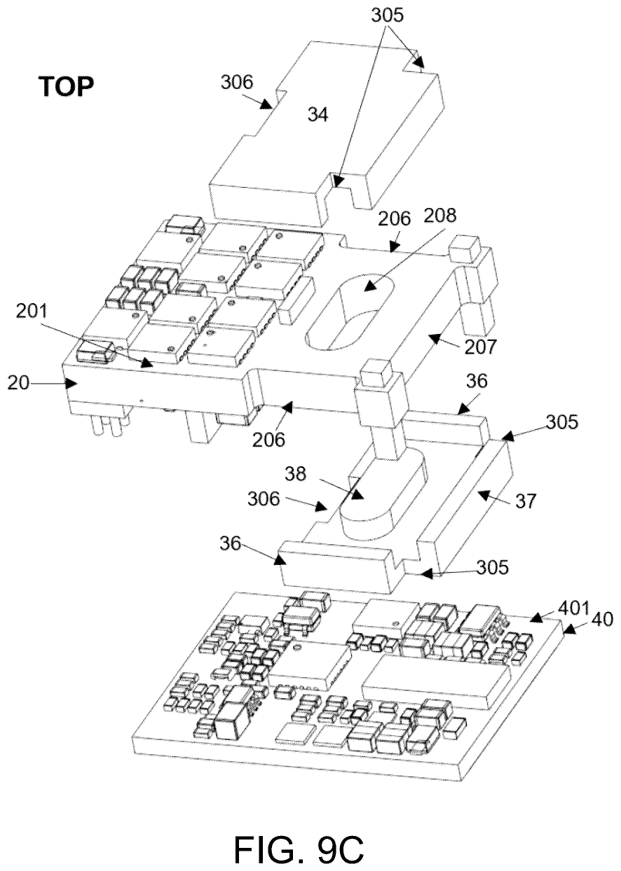

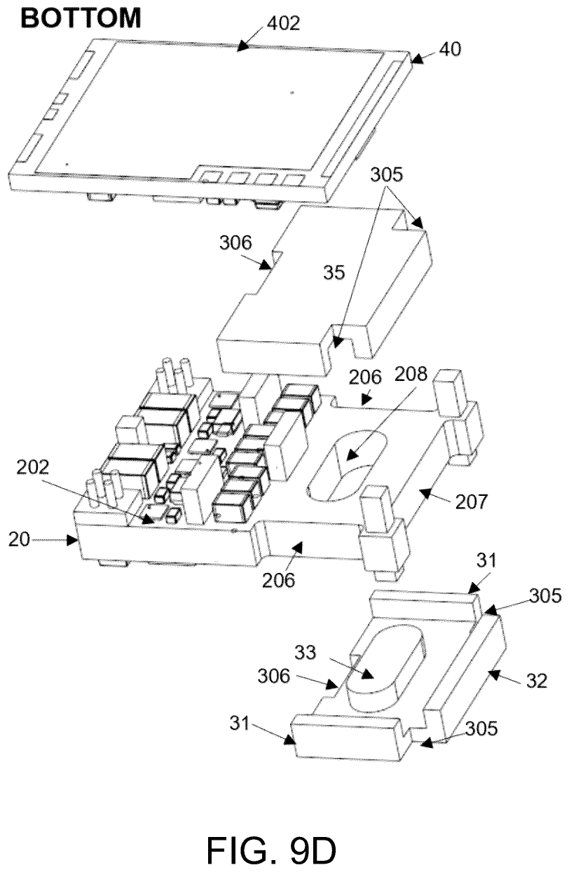

In order to obtain higher conversion efficiency and lower thermal resistance power conversion device, the present application further optimizes the structure of the magnetic component and the structural layout of the device. FIG. 9A is a perspective top view of the power conversion device, and FIG. 9B is a perspective bottom view of the power conversion device. The power conversion device comprises a second substrate 20. The second substrate comprises an upper surface 201 and a lower surface 202 which are opposite each other. The magnetic assembly comprises a magnetic core assembly 30 and a winding, and the winding is provided inside or on the surface of the second substrate 20. Referring to the explosion schematic diagram shown in FIGS. 9C and 9D, the magnetic core assembly 30 comprises an upper magnetic plate 34, a lower magnetic plate 35, two first side columns 36, a second side column 37 and a middle column 38; The two first side columns 36 are disposed adjacent to the second side 302 and the fourth side 304, respectively, and the second side column 37 are disposed adjacent to the third side 303; here, the second side 302 and the fourth side 304 are located opposite each other, and the third side 303 is located between the second side 302 and the fourth side 304. The middle column 38 is arranged between the two first side columns 36 and is adjacent to the second side column 37, so that the middle column 38 is surrounded by the two first side columns 36 and one second side column 37, and the surrounded angle around the middle column 38 is greater than 180 degrees. A channel between the middle column 38 and the two side columns 36 and a channel between the middle column 38 and one side column 37 are connected in series. The series channel is used for placing the high-voltage winding TW11, the low-voltage winding TW 12 and the TW13. The advantages described above are the magnetic flux of the middle column 38, which can not only be closed by means of the two first side columns 36, but can be closed by means of one second side column 37, so that the thickness of the upper magnetic plate 34 or the lower magnetic plate 35 is greatly reduced to the thickness close to the switching device, thereby reducing the upward thermal resistance of the switching device on the second substrate 20. A hole-groove 208, two side-grooves 206 and a side-groove 207 are provided on the second substrate 20. The hole-groove 208 is passed through by the middle column 38, the two side-grooves 206 respectively allow the two first side columns 36 to pass through, and the side-groove 207 is passed through by the second side column 37. The upper magnetic plate 34 and the lower magnetic plate 35 are respectively assembled the second substrate 20 from the upper surface 201 and the lower surface 202; after the assembling, the second side 302, the third side 303, and the fourth side 304 of the magnetic core assembly 30 are both exposed on the side wall of the second substrate 20, so that the surface area of the second substrate 20 is fully utilized, and the area of the power conversion device can be further reduced. In another embodiment, the side-grooves 206 or 207 may also be hole-grooves such that the second side 302, the third side 303, or the fourth side 304 of the magnetic core assembly 30 is not exposed to the sidewalls of the second substrate 20.

The upper magnetic plate 34 and the lower magnetic plate 35 both comprise two first recesses 305 and one second recess 306. One first recess 305 is arranged adjacent to the second side 302 and the third side 303, and the other first recess 305 is arranged adjacent to the fourth side 304 and the third side 303. The second recess 306 is arranged adjacent to the first side 301 and is located in the middle of the first side 301; the first side 301 is opposite to the third side 303. After the magnetic core assembly 30 and the second substrate 20 are assembled, the second substrate 20 is exposed corresponding to the upper surface and the lower surface of the first groove 305, and is used for providing a connector or an electrical connector; in detail, the connectors 151 and 152 are respectively arranged in the first recess 305 of the upper surface 201, the connector 153 is arranged in the second recess 306 of the upper surface 201, and the connector 151/152/153 is used for realizing a mechanical support and a heat dissipation function; the electrical connectors 154 and 155 are respectively disposed in the first recess 305 of the lower surface 202, the electrical connector 156 is disposed in the second recess 306 of the lower surface 202, and the electrical connector 154/155/156 is used to implement the functions of mechanical support, heat dissipation and electrical connection, wherein the electrical connector 156 is an output positive electrical connector.

In the present embodiment, the lower switches SR11, SR12, SR21 and SR22 are arranged adjacent to the first side 301 of the magnetic core assembly, and the lower switches SR11 and SR12 in the first sub-circuit and the lower switches SR21 and SR22 in the second sub-circuit are arranged in a staggered manner, that is, the lower switches SR11 and SR12 and the lower switches SR21 and SR22 in the second sub-circuit are arranged along the first side 301 in the order of the lower switch SR11, the SR21, the SR12, and the SR22. The drain of the lower switch SR11 and the drain of the SR12 are connected in parallel and then electrically connected to the low-voltage winding TW12, and the drain of the lower switch SR21 and the drain of the SR22 are connected in parallel and then electrically connected to the low-voltage winding TW13. The advantage of the above method is that the loop formed by the lower switch SR11 and the low-voltage winding TW12, and the loop formed by the low-voltage winding TW13 and the lower switch SR21, and the minimum parasitic leakage between the two loops; similarly, the loop formed by the lower switch SR12 and the low-voltage winding TW12, and the loop formed by the low-voltage winding TW13 and the lower switch SR22, the parasitic leakage between the two loops is minimized.

On the upper surface 201 of the second substrate 20, the middle switches Q2 and Q4 are arranged adjacent to the lower switch, that is, two parallel Q2 are respectively arranged adjacent to the SR11 and the SR21; and the two parallel Q4 are respectively arranged adjacent to the SR12 and the SR22. The upper switches Q1 and Q3 are respectively arranged adjacent to the middle switches; the upper switches, the middle switches and the lower switches in the same switch bridge arm are sequentially arranged adjacent to each other; that is, the upper switch, the middle switch, the lower switch, and the magnetic core assembly are sequentially arranged in the same direction. In addition, the resonant capacitor C1 is disposed between the upper switches Q 1 and Q3.

On the lower surface 202 of the second substrate 20, the plurality of input capacitors Cin are arranged adjacent to the upper switches Q1 and Q3, that is, the input capacitor Cin is directly opposite to the upper switch Q1 or Q3 (the position positive pair here means that the projection of the input capacitor and the upper switch Q1 or Q3 on the same horizontal plane at least partially overlaps□. The plurality of output capacitors Co are arranged adjacent to the lower switch, that is, the output capacitor Co is directly opposite to the lower switch SR11, the SR21, the SR12 or the SR22. The power conversion device further comprises electrical connectors 157, 158 and 159, wherein the electrical connectors 157 and 158 are disposed adjacent to the output capacitor Co and serve as a ground electrical connector GND; and the output capacitor Co is disposed between the electrical connector 157/158 and the electrical connector 156, further reducing the parasitic resistance and parasitic inductance of the output loop consisting of the output capacitor Co and the electrical connector 157/158 and the electrical connector 156. The electrical connector 159 functions as an input positive connector, and the electrical connector 159 is disposed adjacent to the upper switch and the input capacitor Cin and is located between the input capacitors Cin. The electrical connectors 157, 158 and 159 have the functions of mechanical support, heat dissipation and electrical connection. In the present embodiment, both the connector and the electrical connector are metal columns, and the copper columns are optimal, but not limited thereto. The power conversion device further comprises two signal electrical connectors Sig, wherein the two signal electrical connectors Sig are disposed on two sides of the electrical connector 159 and close to the position of the second substrate plate, and are used for transmitting control signals, sampling and/or monitoring signals, etc. An electrical connector disposed on the lower surface 202 of the second substrate 20 may serve as fixing and electrical connection of the second substrate 20 to the external component.

In another embodiment, the power conversion device further comprises a third substrate 40 comprising an opposing upper surface 401 and a lower surface 402; the control element and/or the plurality of passive elements are provided on the upper surface 401 and the electrical connector provided on the lower surface 202 of the second substrate 20, which is fixed and electrically connected to the upper surface 401 of the third substrate 40 and transmits power and signals between the second substrate 20 and the third substrate 40. A plurality of connecting portions is provided on the lower surface 402 of the third substrate 40. The plurality of connecting portions are electrically connected to the electrical connectors provided on the lower surface 202 of the second substrate 20 by means of the third substrate 40, and the plurality of connecting portions can serve as fixing and electrical connection between the power conversion device and the external components. The plurality of connecting portions may be pads or BGA (Ball Grid Alley).

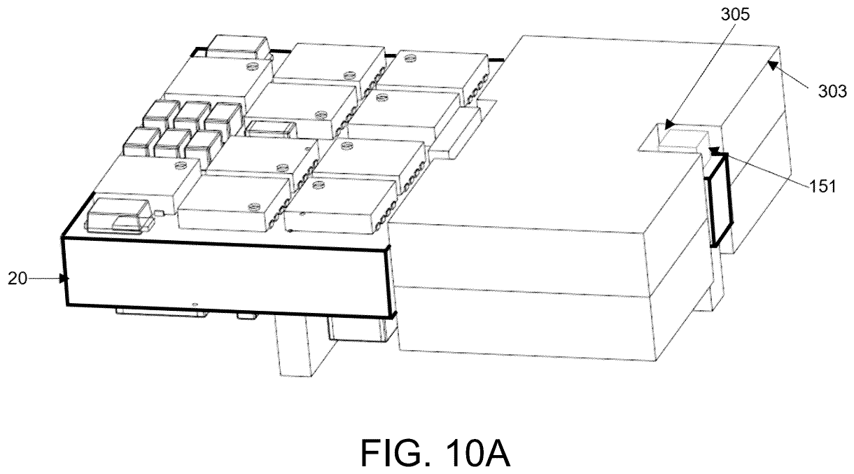

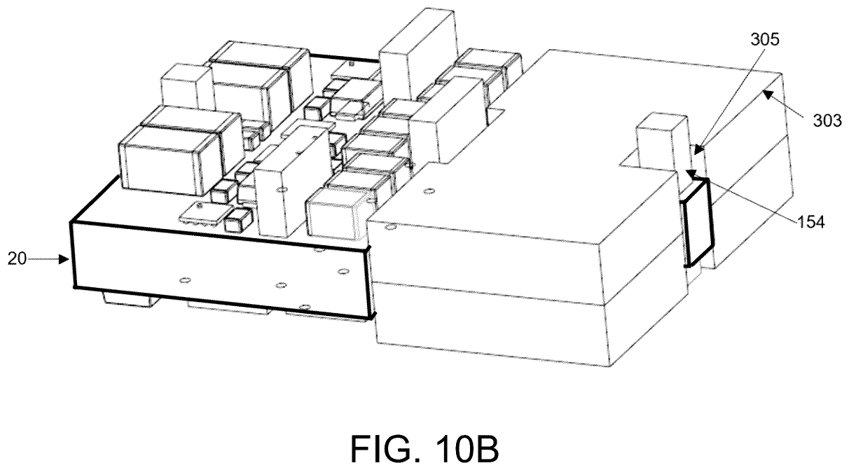

As shown in FIG. 10A and FIG. 10B, the schematic top view and the bottom schematic are different from the previous embodiment in that the third side 303 of the magnetic core assembly 30 comprises only one first recess 305, that is, the first recess 305 is disposed adjacent to the third side 303, and adjacent to the intermediate position of the third side 303; Similarly, the upper surface and the lower surface of the second substrate 20 corresponding to the first recess 305 are respectively used for providing the connector 151 and the electrical connector 154. The connector and the electrical connector have the same technical features and functions as the previous embodiment, and will not be repeated here.

The switch disclosed by the application can be used for realizing the functions of the switch disclosed by the application, such as a Si MOSFET□SiC MOSFET□GaN MOSFET or IGBT MOSFET.

The power supply module according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising a substrate, a magnetic core assembly, and at least two lower switches; wherein the magnetic core assembly comprises a magnetic column, an upper magnetic plate and a lower magnetic plate, and the magnetic column is arranged between the upper magnetic plate and the lower magnetic plate; wherein the substrate comprises a hole-groove and a winding, the winding is arranged in the substrate or on the surface of the substrate, the hole-groove is used for the magnetic column to pass through, the upper magnetic plate and the lower magnetic plate are respectively assembled to the winding from an upper surface of the substrate and a lower surface of the substrate, the at least two lower switches are arranged on the upper surface of the substrate, and the at least two lower switches are respectively arranged on two opposite sides of the magnetic core assembly;
wherein the power conversion device further comprises an input end and an output end, the input end comprises an input positive end and an input negative end, and the output end comprises an output positive end and an output negative end.

2. The power conversion device of claim 1, wherein the magnetic core assembly comprises two magnetic columns, and a channel between the two magnetic columns being a winding channel; wherein the magnetic core assembly further comprises a first side and a third side opposite to each other, and an second side and a fourth side opposite to each other, wherein the winding channel penetrates through the first side and the third side of the magnetic core assembly; wherein the winding comprises a first winding and a second winding, the first winding and the second winding respectively pass through the winding channel once in opposite directions, and a second end of the first winding is electrically connected to a second end of the second winding.

3. The power conversion device of claim 2, wherein the winding further comprises a third winding, and the third winding passes through the winding channel twice.

4. The power conversion device of claim 3, wherein a first end of the third winding is disposed adjacent to a first side of the magnetic core assembly, and a second end of the third winding is disposed adjacent to a third side of the magnetic core;
wherein a winding manner of the third winding is as follows: the third winding from the first end of the third winding to the second end of the third winding, firstly passes through the winding channel in a first direction, is divided into two branches, is wound around the two magnetic columns along the third side, and then converges at the winding channel on the first side, and passes through the winding channel again in the first direction to reach the third side.

5. The power conversion device of claim 4, further comprising a first sub-circuit, a second sub-circuit, a third sub-circuit, and a fourth sub-circuit; wherein each of the first sub-circuit, the second sub-circuit, the third sub-circuit and the fourth sub-circuit comprises a lower switch, an upper switch and a middle switch connected in series in sequence; the upper switches of the first sub-circuit and the second sub-circuit are electrically connected in parallel and are connected in parallel between the input positive end and a first upper node, the middle switches of the first sub-circuit and the second sub-circuit are electrically connected in parallel, one parallel terminal of the two parallel switches is electrically connected to the first upper node, and the other parallel terminal is electrically connected to a first lower node or the input negative end; the at least two lower switches of the first sub-circuit and the second sub-circuit are electrically connected in parallel and connected between the first lower node and the output negative end; the upper switches of the third sub-circuit and the fourth sub-circuit are electrically connected in parallel and connected between the input positive end and a second upper node, the middle switches of the third sub-circuit and the fourth sub-circuit are electrically connected in parallel, one parallel terminal of the two parallel switches is electrically connected to the second upper node, the other parallel terminal is electrically connected to a second lower node or the input negative end, and lower switches of the third sub-circuit and the fourth sub-circuit are electrically connected in parallel and connected between the second lower node and the output negative end.

6. The power conversion device of claim 5, further comprising a resonant capacitor, wherein the first end of the third winding is connected in series with the resonant capacitor and then connected between the first upper node and the second upper node, and a connection point between the first end of the third winding and the resonant capacitor is a series connection point.

7. The power conversion device of claim 5, wherein a first end of the first winding is electrically connected to the first lower node, a first end of the second winding is electrically connected to the second lower node, and a second end of the first winding and a second end of the second winding are electrically connected to the output positive end.

8. The power conversion device of claim 2, wherein a first end of the first winding and the second end of the second winding are arranged adjacent to the first side, and the second end of the first winding and a first end of the second winding are arranged adjacent to the third side; the second end of the first winding and the second end of the second winding are electrically connected by means of an auxiliary connection line, and the auxiliary connection line is arranged around a periphery of the magnetic assembly and forms a closed loop.

9. The power conversion device of claim 5, wherein the lower switches of the first sub-circuit and the second sub-circuit are disposed adjacent to the first side; the lower switches of the third sub-circuit and the fourth sub-circuit are disposed adjacent to the third side.

10. The power conversion device of claim 9, wherein in the first sub-circuit, the upper switch and the middle switch are arranged adjacent to the second side, and the middle switch is arranged adjacent to the lower switch; in the second sub-circuit, the upper switch and the middle switch are disposed adjacent to the fourth side, and the middle switch is disposed adjacent to the lower switch; in the third sub-circuit, the upper switch and the middle switch are disposed adjacent to the second side, and the middle switch is disposed adjacent to the lower switch; in the fourth sub-circuit, the upper switch and the middle switch are disposed adjacent to the fourth side, and the middle switch is disposed adjacent to the lower switch.

11. The power conversion device of claim 10, wherein the substrate comprises a first substrate and a second substrate, the first substrate and the second substrate both comprise an upper surface and a lower surface opposite to each other, and the lower surface of the first substrate is disposed adjacent to the upper surface of the second substrate; wherein the first substrate comprises a hole-groove for accommodating the upper magnetic plate; the second substrate comprises a hole-groove for the magnetic column to pass through; the hole-groove of the second substrate is arranged in a vertical projection area of the hole-groove of the first substrate on the upper surface of the second substrate; and the lower magnetic plate is arranged adjacent to the lower surface of the second substrate.

12. The power conversion device of claim 11, wherein the first substrate and the second substrate are fixed and electrically connected by welding, pressing, or metal columns.

13. The power conversion device of claim 12, wherein an upper surface of the first substrate comprises a first sub-circuit region, a second sub-circuit region, a third sub-circuit region, a fourth sub-circuit region, a first lower switch region and a second lower switch region; the first sub-circuit area is used for arranging the upper switch and the middle switch of the first sub-circuit, the second sub-circuit area is used for arranging the upper switch and the middle switch of the second sub-circuit, the third sub-circuit area is used for arranging the upper switch and the middle switch of the third sub-circuit, and the fourth sub-circuit area is used for arranging the upper switch and the middle switch of the fourth sub-circuit.

14. The power conversion device of claim 13, wherein the lower surface of the second substrate comprises a first output capacitor region, a second output capacitor region, a first input capacitor region, a second input capacitor region, a first resonant capacitor region and a second resonant capacitor region; the first output capacitor region and the second output capacitor region are respectively arranged on the first side and the third side; the first input capacitor region and the second input capacitor region are respectively arranged on the second side and the fourth side and are used for arranging an input capacitor; the first resonant capacitor region and the second resonant capacitor region are respectively arranged on the second side and the fourth side and are used for arranging a resonant capacitor; a projection of the first output capacitor region on the upper surface of the first substrate at least partially overlaps the first lower switch region, and a projection of the second output capacitor region on the upper surface of the first substrate at least partially overlaps the second lower switch region.

15. The power conversion device of claim 14, wherein the first lower switch region is configured to arrange the lower switch of the first sub-circuit and the second sub-circuit, and the second lower switch region is configured to arrange the lower switch of the third sub-circuit and the fourth sub-circuit; and the first output capacitor region and the second output capacitor region are configured to set an output capacitor.

16. The power conversion device of claim 14, wherein the first lower switch region is configured to arrange the lower switch and the output capacitor of the first sub-circuit, the second lower switch region is configured to arrange the lower switch and the output capacitor of the third sub-circuit, the first output capacitor region is configured to arrange the lower switch and the output capacitor of the second sub-circuit, and the second output capacitor region is configured to arrange the lower switch and the output capacitor of the fourth sub-circuit.

17. The power conversion device of claim 12, further comprising a third substrate and a connector, wherein the third substrate comprises an upper surface and a lower surface opposite to each other, and the upper surface of the third substrate is disposed adjacent to the lower surface of the second substrate; the connector is disposed between the upper surface of the third substrate and the lower surface of the second substrate for being fixed and electrically connected to the second substrate and the third substrate; the lower surface of the third substrate is provided with a connecting portion for being fixed and electrically connected to an external assembly; the connector is configured to transmit a signal and/or transmit energy.

18. The power conversion device of claim 11, further comprising a third substrate, wherein the third substrate comprises an upper surface and a lower surface opposite to each other, and the upper surface of the third substrate is disposed adjacent to the lower surface of the second substrate; the first substrate, the second substrate, and the third substrate are fixed and electrically connected by means of a metal column, wherein the second substrate further comprises a hole-groove for the metal column to pass through; the metal column is used for transmitting a signal and/or transferring energy.

19. The power conversion device of claim 4, wherein a first end of the first winding and the second end of the second winding are arranged adjacent to the first side, and the second end of the first winding and a first end of the second winding are arranged adjacent to the third side; the first end of the first winding, the second end of the second winding, and the second end of the third winding are dotted terminals.

20. The power conversion device of claim 5, further comprising a first control signal, a second control signal, a third control signal and a fourth control signal; wherein the first control signal and the second control signal are 180 degrees out of phase, and duty cycles are 0.5; the third control signal is complementary to the first control signal, and the fourth control signal is complementary to the second control signal; the first control signal is used for controlling the turn-on and turn-off of the upper switches of the first sub-circuit and the second sub-circuit, the middle switches the third sub-circuit and the fourth sub-circuit; the second control signal is used for controlling the turn-on and turn-off of the upper switches of the third sub-circuit and the fourth sub-circuit, the middle switches of the first sub-circuit and the second sub-circuit; the third control signal is used for controlling the turn-on and turn-off of the lower switches of the third sub-circuit and the fourth sub-circuit; and the fourth control signal is used for controlling the turn-on and turn-off of the lower switches of the first sub-circuit and the second sub-circuit.

21. The power conversion device of claim 14, wherein the first end of the third winding extends to the second side and the fourth side along the first side, and is electrically connected to a connection point provided in the first resonant capacitor area and the second resonant capacitor area, respectively; the second end of the third winding extends to the second side and the fourth side along the third side, respectively, and is electrically connected to the second upper node provided in the third sub-circuit area and the fourth sub-circuit area, respectively.

22. A magnetic assembly, comprising a substrate and a magnetic core assembly, wherein the magnetic core assembly comprises a magnetic column, an upper magnetic plate and a lower magnetic plate, and the magnetic column is arranged between the upper magnetic plate and the lower magnetic plate; wherein the magnetic core assembly comprises a first side and a third side opposite to each other, and a second side and a fourth side opposite to each other;
wherein the substrate comprises a hole-groove and a winding, the winding is arranged in the substrate or on the surface of the substrate, the hole-groove is used for the magnetic column to pass through, and the upper magnetic plate and the lower magnetic plate are respectively assembled to the winding from an upper surface of the substrate and a lower surface of the substrate; the magnetic column comprises a middle column, two first side columns and one second side column; the middle column is surrounded by the two first side columns and the second side column, and an enclosed angle around the middle column is greater than 180 degrees; wherein two channels between the middle column and the two first side columns, and a channel between the middle column and the second side column are connected in series, and the series channel is used for arranging the winding.

23. The magnetic assembly of claim 22, wherein the two first side columns are respectively arranged adjacent to the second side of the magnetic core assembly and the fourth side of the magnetic core assembly, the second side column is arranged adjacent to the third side of the magnetic core assembly, and the middle column is arranged between the two first side columns and the second side column; wherein the substrate further comprises two first side-grooves and one second side-groove, the two first side-grooves are respectively used for the two first side columns to pass through, the second side-groove is used for the second side column to pass through, and the hole-grooves allow the middle column to pass through; and after the magnetic core assembly is assembled to the substrate, the second side, the third side and the fourth side of the magnetic core assembly are exposed on a side wall of the substrate.

24. The magnetic assembly of claim 22, wherein the upper magnetic plate and/or the lower magnetic plate comprise a first recess and a second recess, the first recess is disposed adjacent to the third side of the magnetic core assembly, and the second recess is disposed adjacent to the first side of the magnetic core assembly.

25. A power conversion device, comprising two switch bridge arms and a magnetic assembly according to claim 22, wherein each of the two switch bridge arms comprises two lower switches connected in parallel, wherein the four lower switches are arranged along the first side of the magnetic core assembly, and the lower switches of the two switch bridge arms are arranged in a staggered manner; wherein the power conversion device further comprises an input end and an output end, the input end comprises an input positive end and an input negative end, and the output end comprises an output positive end and an output negative end.

26. The power conversion device of claim 25, wherein each of the two switch bridge arms further comprises an upper switch and a middle switch; wherein the upper switch, the middle switch, and the parallelled lower switches in the same switch bridge arm are connected in series in sequence; the middle switch is arranged between the upper switch and the lower switch; the input negative end and the output negative end are short-circuited; each of the two switch bridge arms is connected between the input positive end and the input negative end.

27. The power conversion device of claim 26, wherein drain electrodes of the two lower switches of a first bridge arm of the two switch bridge arms are connected in parallel and then are electrically connected to the winding, and drains of the two lower switches of a second bridge arm of the two switch bridge arms are electrically connected to the winding after being connected in parallel.

28. The power conversion device of claim 26, wherein the upper switch, the middle switch and the lower switch of each of the two switch bridge arms are arranged on the upper surface of the substrate; and the upper switch, the middle switch and the lower switch are sequentially arranged in the same direction.

29. The power conversion device of claim 28, further comprising a resonant capacitor, an input capacitor, and an input positive electrical connector; wherein the resonant capacitor is disposed on the upper surface of the substrate and located between the upper switches of the two switch bridge arms; the input capacitor and the input positive electrical connector are disposed on the lower surface of the substrate and are disposed adjacent to the upper switch.

30. The power conversion device of claim 25, further comprising a connector; wherein the connector is disposed on the first recess and the second recess of the upper magnetic plate or on the first recess of the lower magnetic plate; and the connector is used for heat dissipation and mechanical support.

31. The power conversion device of claim 25, wherein the input negative end and the output negative end are electrical connected; wherein the power conversion device further comprises a output positive electrical connector and a grounding electrical connector; wherein the output positive electrical connector is disposed in the second recess of the lower magnetic plate, and is electrical connected with the output positive end; the grounding electrical connector is disposed adjacent to the output positive electrical connector, and is electrical connector with the input negative end and the output negative end.

32. The power conversion device of claim 31, wherein the upper magnetic plate and/or the lower magnetic plate comprises two first recesses and one second recess; one of the first recesses is disposed adjacent to the second side of the magnetic core assembly and the third side of the magnetic core assembly, and the other first recess is disposed adjacent to the third side of the magnetic core assembly and the fourth side of the magnetic core assembly; and the second recess is disposed adjacent to the first side of the magnetic core assembly.

33. The power conversion device of claim 31, wherein the upper magnetic plate and/or the lower magnetic plate comprise a first recess and a second recess, the first recess is arranged at an intermediate position on the third side, and the second recess is arranged adjacent to the first side of the magnetic core assembly.

34. The power conversion device of claim 31, further comprising another substrate and an input positive electrical connector, wherein the input positive electrical connector is disposed on the lower surface of the substrate; wherein the another substrate comprises an upper surface and a lower surface opposite to each other, and the input positive electrical connector, the output positive electrical connector and the grounding electrical connector are fixed and electrically connected to the another substrate; the lower surface of the another substrate comprises a plurality of connecting portions, the plurality of connecting portions being electrically connected to the electrical connectors by means of the another substrate; and the plurality of connecting portions being used for being fixed and electrically connected to an external assembly.
